(19) United States
(12) Patent Application Publication
(10) Pub. No.: US 2005/0265314 A1
(43) Pub. Date: Dec. 1, 2005

(54) Method for establishing a voice communications link through the internet community

(75) Inventors: Chun-I Wu, Taichung City (TW); Hung-Yu Lin, Taichung City (TW); Cheng-Yang Lou, Taichung City (TW)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: OCTTEL COMMUNICATION CO., LTD.

(21) Appl. No.: 10/968,337

(22) Filed: Oct. 20, 2004

(30) Foreign Application Priority Data
May 28, 2004 (TW) 093115328

(51) Int. Cl. H04L 12/66

(52) U.S. Cl. 370/352; 370/401

(57) ABSTRACT

A method, which establishes a voice communications link through the internet community, includes the step of configuring a gateway to use a mapping table to translate input identification data of a called party to a corresponding internet protocol address of another gateway associated with the called party. The method is relatively simple as compared to existing voice over internet protocols.

### CROSS-REFERENCE TO RELATED APPLICATION

This application claims priority of Taiwanese application no. 093115328, filed on May 28, 2004.

### BACKGROUND OF THE INVENTION

1. Field of the Invention

The invention relates to a method for establishing a voice communications link through the internet community, more particularly to a method that is relatively easy to implement as compared to existing voice over internet protocols.

2. Description of the Related Art

Conventional voice over internet protocols such as H.323, media gateway control protocol (MGCP), and session initiation protocol (SIP) are interoperable. That is, a system that implements one of the H.323, MGCP, and SIP is able to establish a voice communications link through the internet community with another system that also implements one of the H.323, MGCP, and SIP.

The aforementioned conventional protocols are disadvantageous in that they conform to industry standards for compatibility consideration. As such, the conventional protocols are relatively complex to implement.

### SUMMARY OF THE INVENTION

Therefore, the object of the present invention is to provide a method for establishing a voice communications link through the internet community that is relatively easy to implement as compared to existing voice over internet protocols.

According to the present invention, a method for establishing a voice communications link through the internet community comprises the step of configuring a gateway to use a mapping table to translate input identification data of a called party to a corresponding internet protocol address of another gateway associated with the called party.

### BRIEF DESCRIPTION OF THE DRAWINGS

Other features and advantages of the present invention will become apparent in the following detailed description of the preferred embodiment with reference to the accompanying drawings, of which:

FIGS. 1A to 1F, 2A to 2E, and 3 are flowcharts of the preferred embodiment of a method for establishing a voice communications link through the internet community;

FIG. 4 is a schematic view to illustrate how a calling gateway acquires an internet protocol address of a called gateway; and

FIGS. 5 to 7 illustrate various call scenarios between the calling and called gateways.

### DETAILED DESCRIPTION OF THE PREFERRED EMBODIMENT

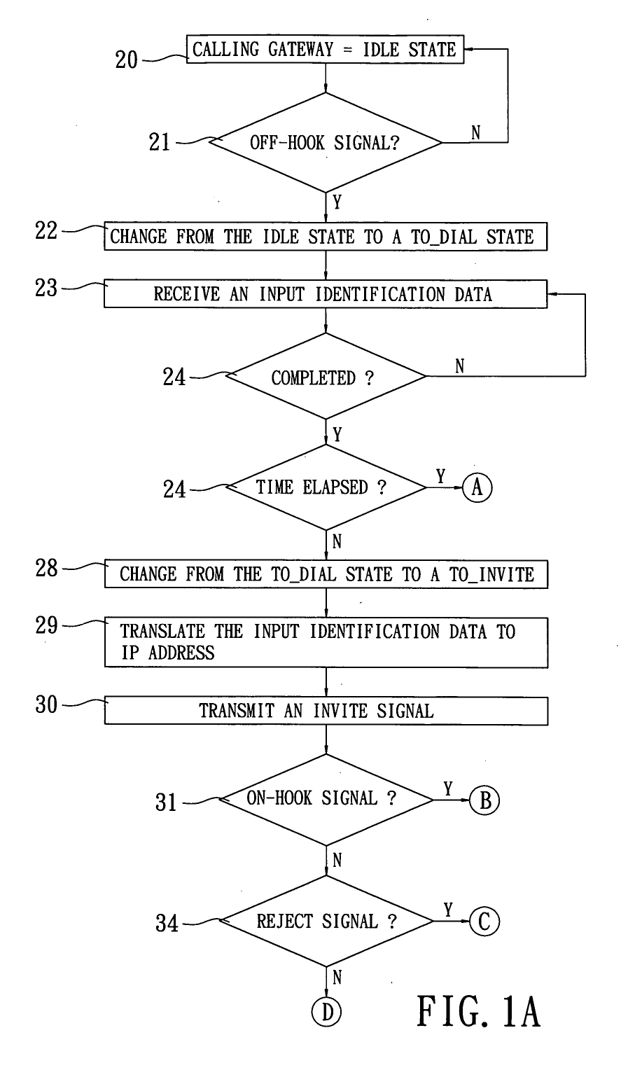

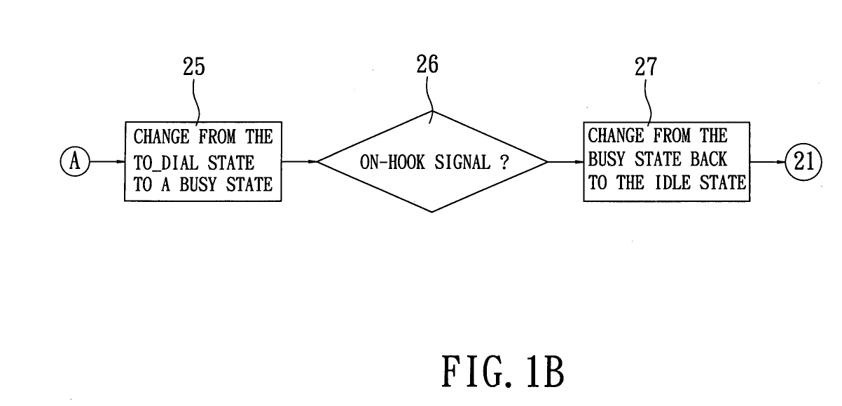

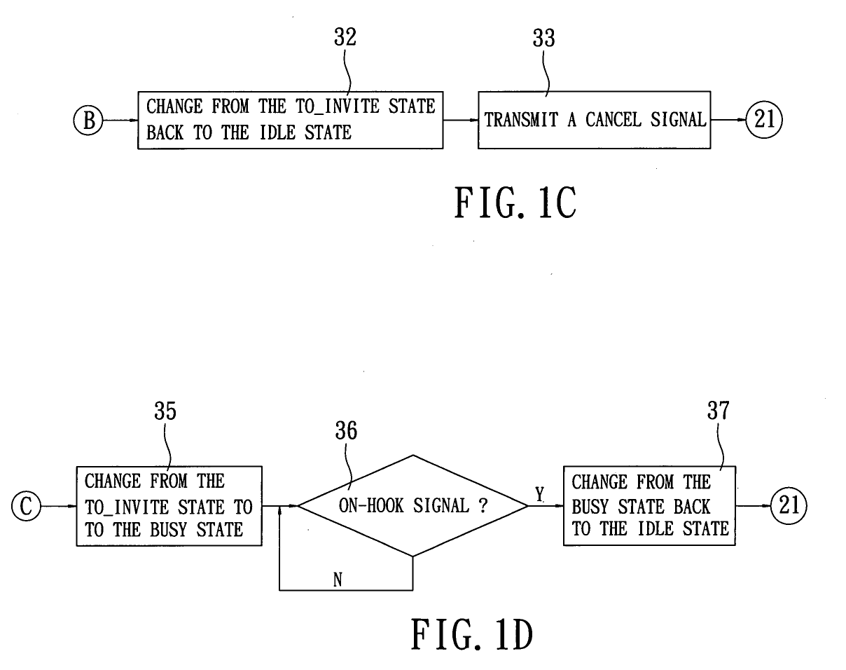

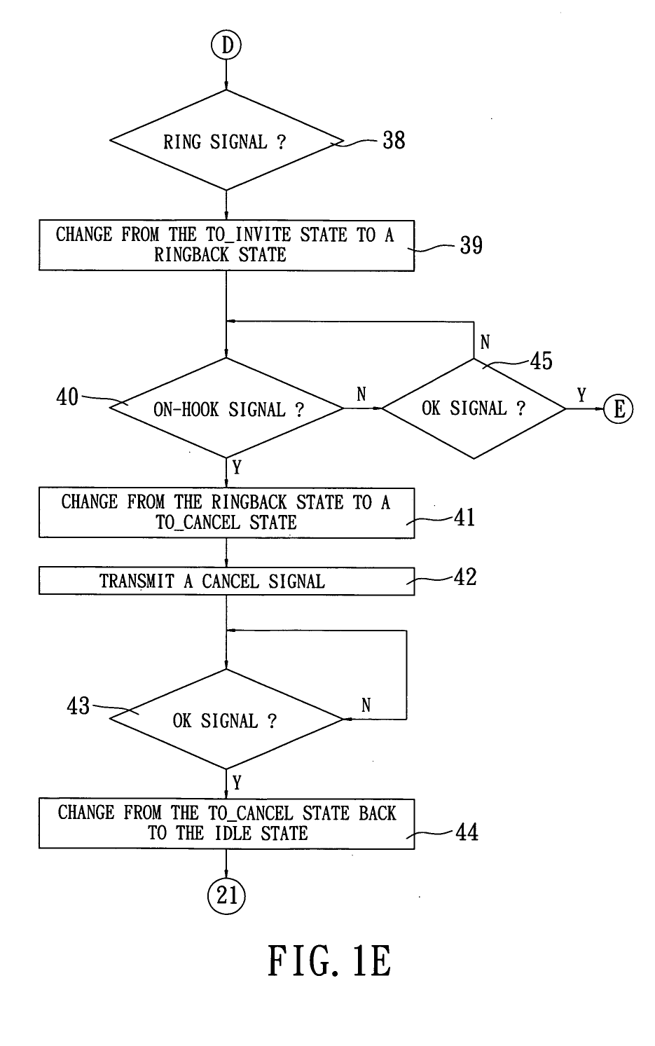

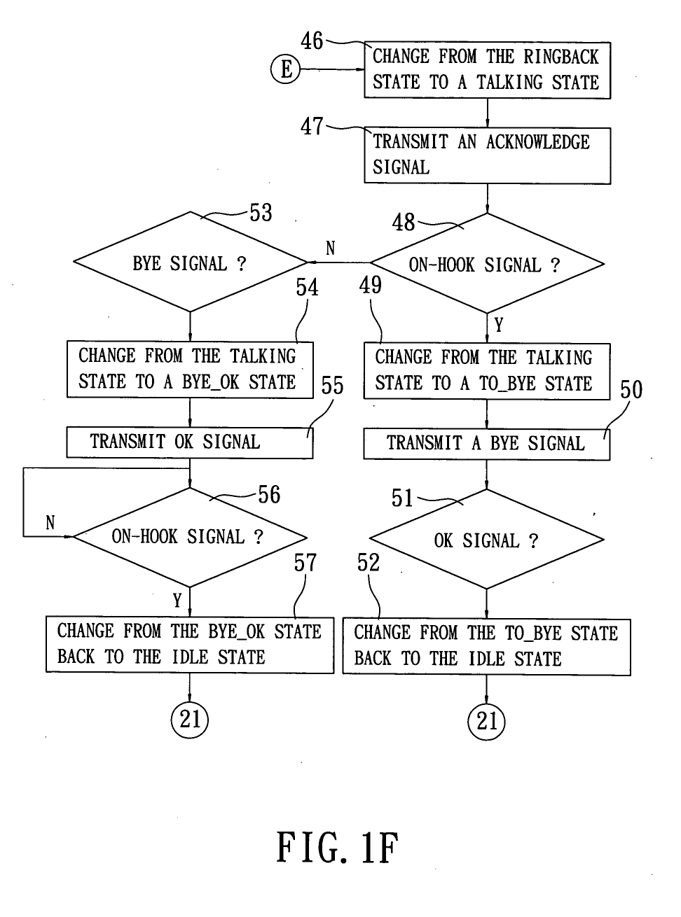

The preferred embodiment of a method for establishing a voice communications link through the internet community according to this invention includes the steps shown in FIGS. 1A and 1F.

The method is implemented in a gateway (not shown), and is in the form of program instructions that is written in C language.

Although the method of this invention is exemplified as written in a C language, it should be apparent to those skilled in the art that the method may be implemented in any other high-level language.

The gateway conforms to the transmission control protocol (TCP) and the real-time transport protocol (RTP).

Initially, in step 20, the gateway (hereinafter referred to as the calling gateway) is in an idle state.

It is noted that the calling gateway is associated with a calling party. The calling party may be in the form of a conventional telephone set.

In step 21, when the calling gateway detects an off-hook signal, i.e., the handset of the calling party is lifted, in step 22, in response to the off-hook signal, the calling gateway changes from the idle state to a to_dial state. At this time, a dial tone is audible from the handset of the calling party.

In step 23, the calling gateway receives input identification data of a called party.

In step 24, when receipt of the input identification data is not completed within a predetermined time period, the flow proceeds to step 25. On the other hand, when receipt of the input identification data is completed within a predetermined time period, the flow proceeds to step 28.

In step 25, the calling gateway changes from the to_dial state to a busy state. In step 26, when the calling gateway detects a non-hook signal, in step 27, in response to the on-hook signal, the calling gateway changes from the busy state back to the idle state. Thereafter, the flow goes back to step 21.

In step 28, the calling gateway changes from the to_dial state to a to_invite state.

In step 29, the calling gateway, with the use of a mapping table, translates the input identification data of the called party to a corresponding internet protocol (IP) address of another gateway (hereinafter referred to as the called gateway) associated with the called party. Likewise, the called party may be in the form of a conventional telephone set.

It is noted that the mapping table maps the input identification data of the called party to the IP address of the called gateway.

The calling gateway then creates a socket to initiate a connection request to the called gateway using the IP address of the called gateway. When the called gateway accepts the connection request from the calling gateway, a socket connection is created between the calling and called gateways. Thereafter, in step 30, the calling gateway invites the called gateway into a session by transmitting an invite signal to the called gateway.

In step 31, when the calling gateway detects an on-hook signal, the flow proceeds to step 32, otherwise, the flow proceeds to step 34.

In step 32, in response to the on-hook signal, the calling gateway changes from the to_invite state back to the idle state, and in step 33, transmits a cancel signal to the called gateway. Subsequently, the calling party closes its socket, thereby disconnecting the socket connection between the calling and called gateways. Thereafter, the flow goes back to step 21.

In step 34, when the calling gateway receives a reject signal from the called gateway, i.e., the called gateway is unable to accept the session invitation, the flow proceeds to step 35. Otherwise, the flow proceeds to step 38.

In step 35, in response to the reject signal, the calling gateway changes from the to_invite state to the busy state. At this time, a busy tone is audible from the handset of the calling party. The calling gateway then closes its socket, thereby disconnecting the socket connection between the calling and called gateways. In step 36, when the calling gateway detects an on-hook signal, in step 37, in response to the on-hook signal, the calling gateway changes from the busy state back to the idle state. Thereafter, the flow goes back to step 21.

In step 38, when the calling gateway receives a ring signal from the called gateway, i.e., the called gateway is able to accept the session invitation, the flow proceeds to step 39. Otherwise, the flow goes back to step 31.

In step 39, in response to the ring signal, the calling gateway changes from the to_invite state to a ringback state. At this time, a ring tone is audible from the handset of the calling party.

In step 40, when the calling gateway detects an on-hook signal, the flow proceeds to step 41. Otherwise, the flow proceeds to step 45.

In step 41, in response to the on-hook signal, the calling gateway changes from the ringback state to a to_cancel state, and in step 42, transmits a cancel signal to the called gateway. In step 43, when the calling gateway receives an ok signal, in step 44, in response to the ok signal, the calling gateway changes from the to_cancel state back to the idle state. Subsequently, the calling gateway closes its socket, thereby disconnecting the socket connection between the calling and called gateways. Thereafter, the flow goes back to step 21.

In step 45, when the calling gateway receives an ok signal, the flow proceeds to step 46. Otherwise, the flow goes back to step 40.

In step 46, in response to the ok signal, the calling gateway changes from the ringback state to a talking state, and in step 47, transmits an acknowledge signal to the called gateway. Subsequently, the calling gateway establishes a RTP channel with the called gateway. Thereafter, when the called gateway establishes a RTP channel with the calling gateway, a two-way voice communications link is established between the called and calling gateways through the internet community.

In step 48, when the calling party detects anon-hook signal, the flow proceeds to step 49. Otherwise, the flow proceeds to step 53.

In step 49, in response to the on-hook signal, the calling gateway changes from the talking state to a to_bye state, and in step 50, transmits a bye signal to the called gateway. In step 51, when the calling gateway receives the ok signal, in step 52, in response to the ok signal, the calling gateway changes from the to_bye state back to the idle state. Subsequently, the calling gateway closes its socket, thereby disconnecting the socket connection between the calling and called gateways. Thereafter, the flow goes back to step 21.

In step 53, when the calling party receives a bye signal, the flow proceeds to step 54. Otherwise, the flow goes back to step 48.

In step 54, in response to the bye signal, the calling gateway changes from the talking state to a bye_ok state, and in step 55, transmits an ok signal to the called gateway. Subsequently, the calling gateway closes its socket, thereby disconnecting the socket connection between the calling and called gateways. In step 56, when the calling gateway detects an on-hook signal, in step 57, the calling gateway changes from the bye_ok state back to the idle state. Thereafter, the flow goes back to step 21.

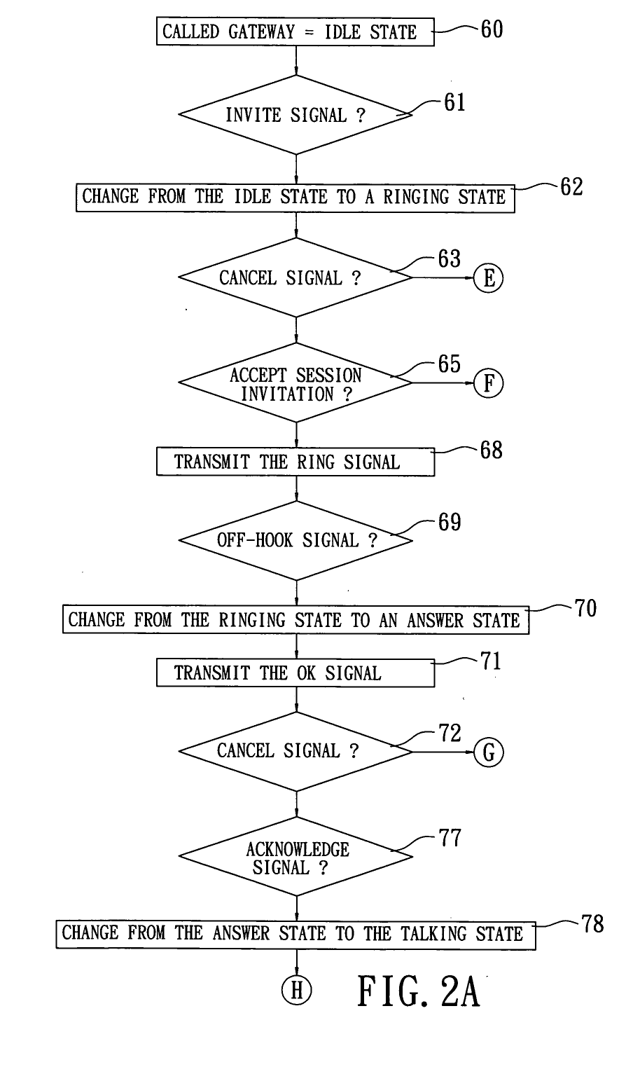

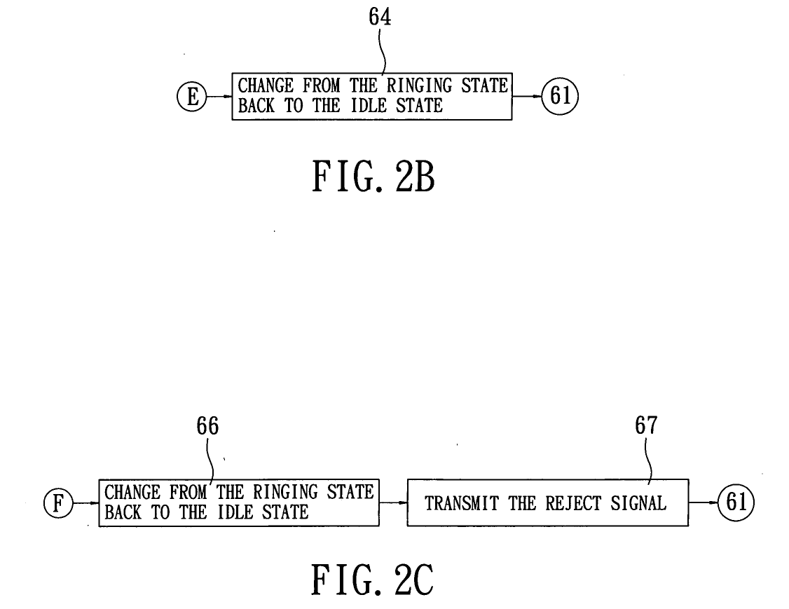

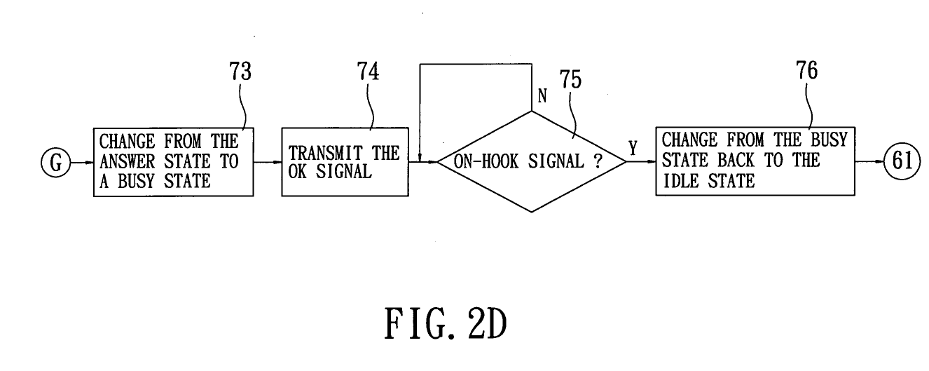

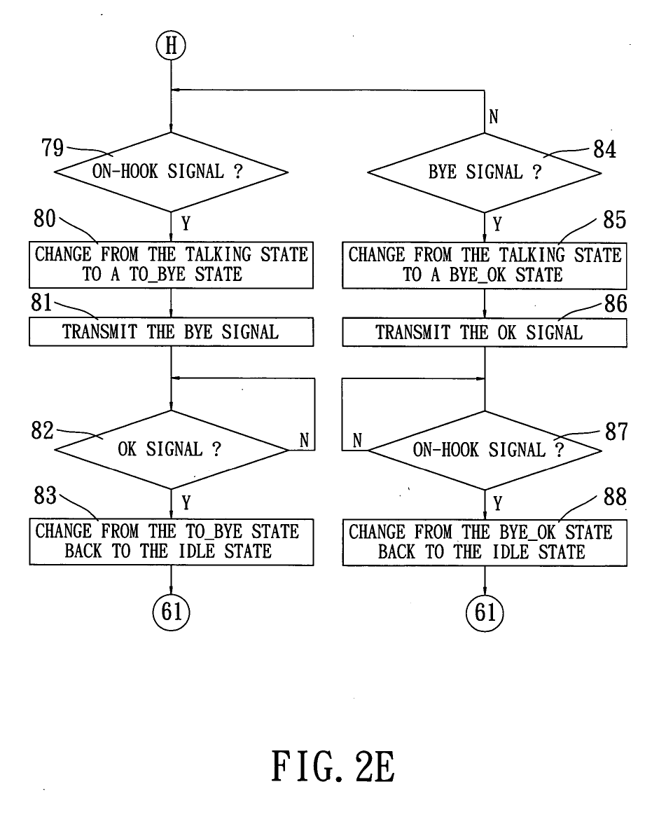

The method of this invention further includes the steps shown in FIGS. 2A and 2E.

Initially, in step 60, the called gateway is in an idle state.

At this time, the called gateway creates a server socket, and binds the server socket to a port number, such as 1688. Thereafter, the called gateway monitors the server socket for the connection request from the calling gateway.

When the called gateway receives a connection request from the calling gateway, the called gateway accepts the connection request, thereby creating the socket connection between the calling and called gateways.

In step 61, when the called gateway receives the invite signal, in step 62, in response to the invite signal, the called gateway changes from the idle state to a ringing state.

In step 63, when the called gateway receives the cancel signal, the flow proceeds to step 64. Otherwise, the flow proceeds to step 65.

In step 64, in response to the cancel signal, the called gateway changes from the ringing state back to the idle state. Thereafter, the flow goes back to step 61.

In step 65, when the called gateway is unable to accept the session invitation, the flow proceeds to step 66. Otherwise, the flow proceeds to step 68.

In step 66, the called gateway changes from the ringing state back to the idle state, and in step 67, transmits the reject signal to the calling gateway. Thereafter, the flow goes back to step 61.

In step 68, the called gateway transmits the ring signal to the calling gateway. At this time, the called party generates a ringing signal to indicate an incoming call.

In step 69, when the called gateway detects an off-hook signal, i.e., the handset of the called party is lifted, in step 70, in response to the off-hook signal, the called gateway changes from the ringing state to an answer state, and in step 71, transmits the ok signal to the calling gateway.

In step 72, when the called gateway receives a cancel signal, the flow proceeds to step 73. Otherwise, the flow proceeds to step 77.

In step 73, in response to the cancel signal, the called gateway changes from the answer state to a busy state, and in step 74, transmits the ok signal to the calling gateway. In step 75, when the called gateway detects an on-hook signal, in step 76, in response to the on-hook signal, the called gateway changes from the busy state back to the idle state. Thereafter, the flow goes back to step 61.

In step 77, when the called gateway receives the acknowledge signal, the flow proceeds to step 78. Otherwise, the flow goes back to step 72.

In step 78, in response to the acknowledge signal, the called gateway changes from the answer state to the talking state. Subsequently, the called gateway establishes a RTP channel with the calling gateway, thereby establishing the two-way voice communications link between the called and calling gateways through the internet community.

In step 79, when the called party detects an on-hook signal, the flow proceeds to step 80. Otherwise, the flow proceeds to step 84.

In step 80, in response to the on-hook signal, the called gateway changes from the talking state to a to_bye state, and in step 81, transmits the bye signal to the calling gateway. In step 82, when the called gateway receives the ok signal, in step 83, in response to the ok signal, the called gateway changes from the to_bye state back to the idle state. Thereafter, the flow goes back to step 61.

In step 84, when the called party receives the bye signal, in step 85, in response to the bye signal, the called gateway changes from the talking state to a bye_ok state, and in step 86, transmits an ok signal to the calling gateway. In step 87, when the called gateway detects an on-hook signal, in step 88, in response to the on-hook signal, the called gateway changes from the bye_ok state back to the idle state. Thereafter, the flow goes back to step 61.

It is noted herein that each of the invite, reject, ring, cancel, ok, acknowledge, and bye signals is transmitted as a data packet. Moreover, the calling gateway may operate as a called gateway. Similarly, the called gateway may operate as a calling gateway.

The input identification data of the called party includes an identification number, a public switched telephone network (PSTN) number, a speed dialing code number, and an extension number.

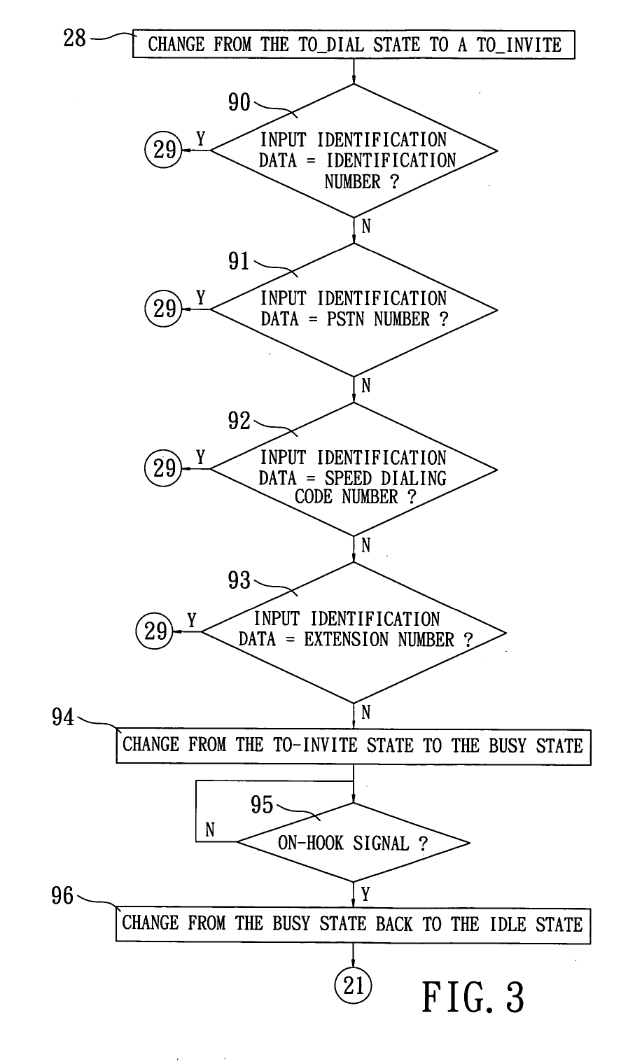

The method of this invention further includes the steps shown in FIG. 3.

In step 90, the calling gateway determines whether the input identification data is the identification number of the called party. If yes, the flow proceeds to step 29. Otherwise, the flow proceeds to step 91.

In step 91, the calling gateway determines whether the input identification data is the PSTN number of the called party. If yes, the flow proceeds to step 29.

Otherwise, the flow proceeds to step 92.

In step 92, the calling gateway determines whether the input identification data is the speed dialing code number of the called party. If yes, the flow proceeds to step 29. Otherwise, the flow proceeds to step 93.

In step 93, the calling gateway determines whether the input identification data is the extension number of the called party. If yes, the flow proceeds to step 29. Otherwise, the flow proceeds to step 94.

In step 94, the calling gateway changes from the to-invite state to the busy state. In step 95, when the calling gateway detects an on-hook signal, in step 96, in response to the on-hook signal, the calling gateway changes from the busy state back to the idle state. Thereafter, the flow goes back to step 21.

The method further includes the step of updating gateway settings, such as the mapping table, the TCP port number, and the IP address. It is noted that the gateway setting may be updated manually through one of an interactive voice response (IVR), a user interface, and a web-based service.

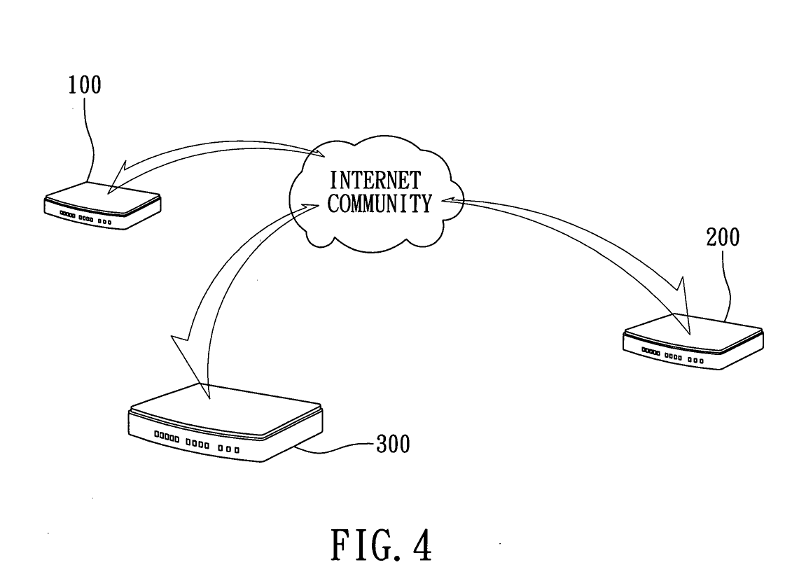

It is noted that, in this embodiment, the mapping table is maintained by the calling gateway. In an alternative embodiment, as illustrated in FIG. 4, the mapping table is maintained by another gateway 300 (herein referred to as a phonebook management gateway) The phonebook management gateway 300, like the calling and called gateways 100, 200, is connected to the internet community. In this embodiment, the method further includes the step of configuring the calling party 100 to request the IP address of the called gateway 200 from the phonebook management gateway 300.

It is also noted that, in this embodiment, the called gateway is connected directly to the internet community. In an alternative embodiment, the called gateway is connected to the internet community through a dynamic domain name server (DDNS). In this embodiment, the method further includes the step of configuring the called gateway to report its IP address to the DDNS.

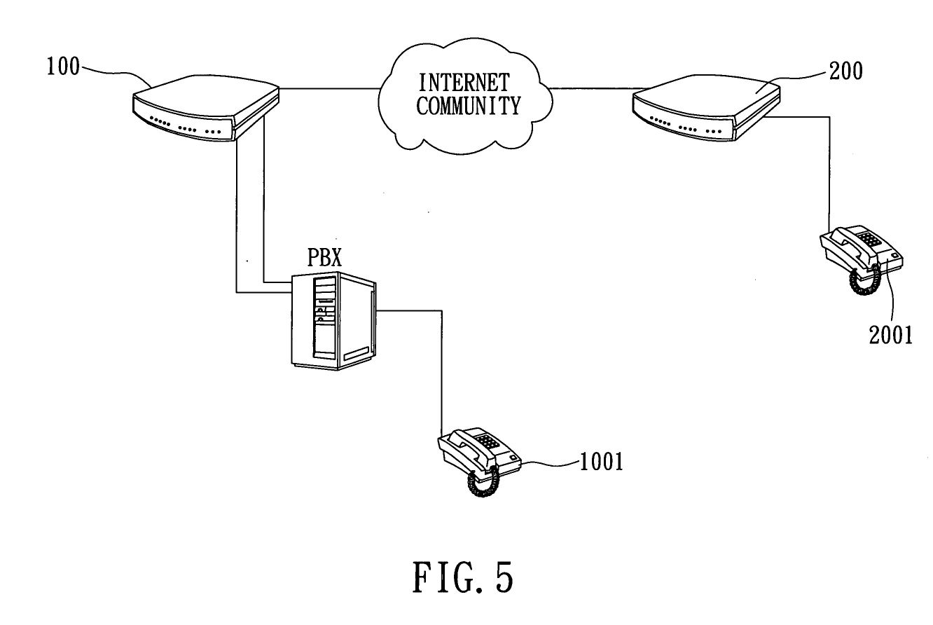

FIG. 5 illustrates a first call scenario between the calling and called gateways 100, 200. In this scenario, the calling party 1001 is connected to the calling gateway 100 through a private branch exchange (PBX), whereas the called party 2001 is connected directly to the called gateway 200.

When it is desired to established a voice communications link between the calling and called gateways 100, 200, an access code, e.g. a “9”, is first dialed into the calling party 1001 to access a VoIP line followed by the identification data of the called party 2001. The identification data is the identification number of the called party 2001.

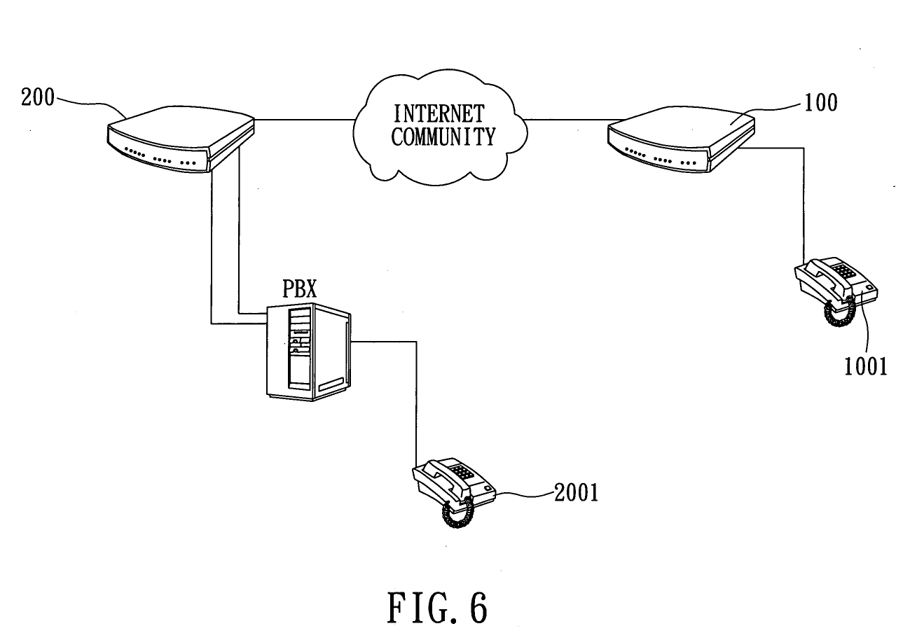

FIG. 6 illustrates a second call scenario between the calling and called gateways 100, 200. In this scenario, the calling party 1001 is connected directly to the calling gateway 100, whereas the called party 2001 is connected to the called gateway 200 through the PBX.

When it is desired to establish a voice communications link between the calling and called gateways 100, 200, the identification data of the called party 2001 is dialed into the calling party 1001. The identification data is the extension number of the called party 2001.

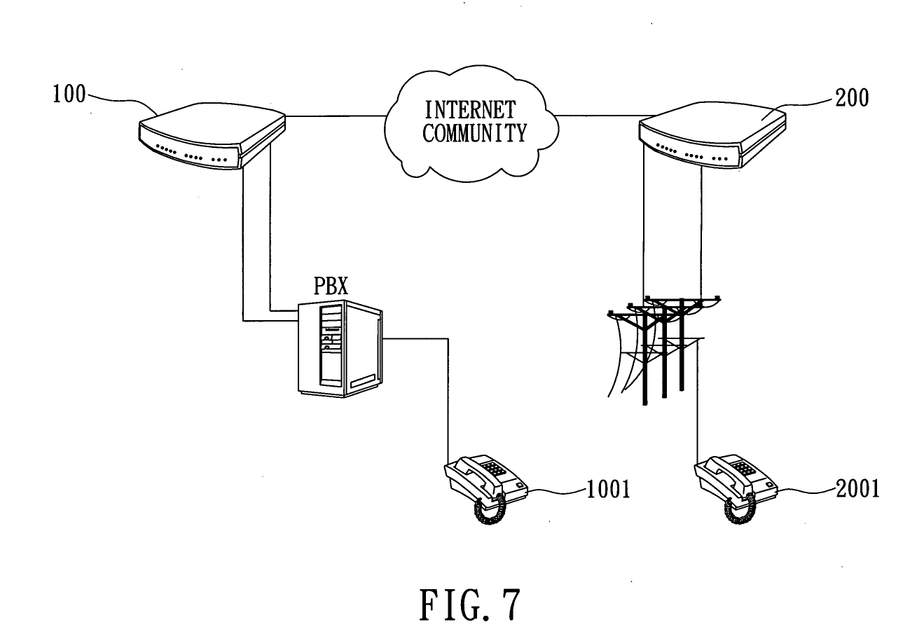

FIG. 7 illustrates a third call scenario between the calling and called gateways 100, 200. In this scenario, the calling party 1001 is connected to the calling gateway 100 through the PBX, whereas the called party 2001 is connected to the called gateway 200 through a PSTN.

When it is desired to establish a voice communications link between the calling and called gateways 100, 200, an access code, e.g. a “9”, is first dialed into the calling party 1001 to access a VoIP line followed by the identification data of the called party 2001. The identification data is the PSTN number of the called party 2001.

It is noted that when the calling and called gateways 100, 200 in the aforementioned call scenarios are located in different countries, the country and area codes are dialed into the calling party 1001 prior to the identification data of the called party 2001.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

1. A method for establishing a voice communications link through the internet community, said method comprising the step of:
(A) configuring a gateway to use a mapping table to translate input identification data of a called party to a corresponding internet protocol (IP) address of another gateway associated with the called party.

2. The method as claimed in claim 1, further comprising the steps of:
prior to step (A), changing the state of the gateway from an idle state to a to_dial state when the gateway detects an off-hook signal;
enabling the gateway to receive the input identification data;
changing the state of the gateway from the to-dial state to a to_invite state when receipt of the input identification data is completed within a predetermined time period;
after step (A), changing the state of the gateway from the to_invite state to a ringback state when the gateway receives a ring signal;
enabling the gateway to transmit an acknowledge signal and changing the state of the gateway from the ringback state to a talking state when the gateway receives an ok signal;
changing the state of the gateway from the talking state to a bye_ok state when the gateway receives a bye signal; and
changing the state of the gateway from the bye_ok state to the idle state when the gateway detects an on-hook signal.

3. The method as claimed in claim 2, further comprising the steps of:
changing the state of the gateway from the to-dial state to a busy state when receipt of the input identification data is not completed within the predetermined time period; and
changing the state of the gateway from the busy state to the idle state when the gateway detects the on-hook signal.

4. The method as claimed in claim 2, further comprising the steps of:
changing the state of the gateway from the to_invite state to a busy state when the gateway does not receive the ring signal; and
changing the state of the gateway from the busy state to the idle state when the gateway detects the on-hook signal.

5. The method as claimed in claim 2, further comprising the step of:
changing the state of the gateway from the to_invite state to the idle state when the gateway detects the on-hook signal.

6. The method as claimed in claim 2, further comprising the steps of:
changing the state of the gateway from the ringback state to a to_cancel state when the gateway detects the on-hook signal; and
changing the state of the gateway from the to_cancel state to the idle state when the gateway receives the ok signal.

7. The method as claimed in claim 2, further comprising the steps of:
changing the state of the gateway from the talking state to the to_bye state when the gateway detects the on-hook signal; and
changing the state of the gateway from the to_bye state to the idle state when the gateway receives the ok signal.

8. The method as claimed in claim 2, further comprising the steps of:
changing the state of the gateway from the idle state to a ringing state when the gateway receives an invite signal;
enabling the gateway to transmit the ok signal and changing the state of the gateway from the ringing state to a to_answer state when the gateway detects the off-hook signal;
changing the state of the gateway from the to_answer state to a talking state when the gateway receives the acknowledge signal;
changing the state of the gateway from the talking state to a to_bye state when the gateway detects the on-hook signal; and
changing the state of the gateway from the to_bye state to the idle state when the gateway receives the ok signal.

9. The method as claimed in claim 8, further comprising the step of:
changing the state of the gateway from the ringing state to the idle state when the gateway receives a cancel signal.

10. The method as claimed in claim 8, further comprising the steps of:
changing the state of the gateway from the to_answer state to a busy state when the gateway receives a cancel signal; and
changing the state of the gateway from the busy state to the idle state when the gateway detects the on-hook signal.

11. The method as claimed in claim 1, wherein the gateway conforms to the transmission control protocol (TCP).

12. The method as claimed in claim 1, wherein the gateway conforms to the real-time transport protocol (RTP).

13. The method as claimed in claim 1, wherein the input identification data includes an identification number.

14. The method as claimed in claim 1, wherein the input identification data includes a speed dialing code number.

15. The method as claimed in claim 1, further comprising the step of manually updating gateway settings through one of an interactive voice response (IVR), a user interface, and a web-based service.

16. The method as claimed in claim 1, further comprising the step of configuring the gateway to report the IP address to a dynamic domain name server.
